(19) United States
(12) Patent Application Publication
(10) Pub. No.: US 2009/0224474 A1
(43) Pub. Date: Sep. 10, 2009

(54) Big Event, Air Drop Lottery System

(76) Inventor: Robert C. Weaver, Payette, ID (US)

Correspondence Address: DEAN A. CRAINE, SUITE 208, 9 - IAKE BELLEVUE DRIVE, BELLEVUE, WA, 98005, US

(21) Appl. No.: 12/398,851

(22) Filed: Mar. 5, 2009

Related U.S. Application Data
(60) Provisional application No. 61/068,391, filed on Mar. 5, 2008.

(51) Int. Cl. G07C 15/00

(52) U.S. Cl. 273/144 R

(57) ABSTRACT

A big event, air drop lottery system that includes a lifting apparatus, such as a helicopter, a hot air balloon, or a crane, that lifts a large container filled with a large quantity of ping pong balls that include a lottery number or unique identifier that matches a lottery number or unique identifier on a ticket stub held by a participate or spectator. Located on the ground below the container is a target area. The container includes a lower opening that enables the ball to be selectively released when lifted to a desired height above the target area. Located inside the target area is a target pole. Attached or mounted on the pole is at least one optional cup designed to catch a ball dropped from the container. A second, third and fourth cup may be mounted or placed adjacent to the pole that may be used to determine second, third and fourth place winners. During play, the target area cleared of all spectators and the container is lifted to a desired elevation. The balls are then released from the container so that a ball that is retained by a cup on the pole or the ball closest to the target is declared the winning ball. The spectator holding the ticket stub with a lottery number that matches the lottery number on the winning ball is declared the lottery winner.

This utility patent application is based on and claims the filing date of the provisional patent application (Ser. No. 61/068,391) filed on Mar. 5, 2008.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to lottery systems, and more particularly to lottery systems designed for large entertaining presentations.

2. Description of the Related Art

The selection of a lottery number for a large public lottery is often a formal event presented in front of large audiences on the radio or television. An important objective of the lottery operator is to create an environment during the selection process that is not only fun and exciting, but also connotes high quality and professionalism. It is important that good well be established to all viewers and that the selection process is considered fair so more people participate in the lottery in the future.

It is an object of the present invention to provide a large visual lottery that can be presented in a fun, entertaining and unique manner.

### SUMMARY OF THE INVENTION

Disclosed herein is a big event, air drop lottery system that includes a lifting apparatus, such as a helicopter, a hot air balloon, or a crane that lifts a large container filled with a large quantity of ping pong balls. Each ball includes a unique identifier that matches the unique identifier on a ticket stub held by a participant. The container includes a lower opening that enables the entire quantity of balls to be released from the container when lifted to a desired height above a target area. In the preferred embodiment, the target structure is a pole positioned in the center of a target area. A cup is attached to the pole's upper end designed to catch one of the balls dropped from the container. A second, third and fourth cup is used to catch additional balls attached at lower levels on the pole or on the ground around the pole.

During play, the target area is cleared of all spectators. The pole is then assembled in the center of the target area and the container, filled with a plurality of balls, is lifted to a desired elevation. All of the balls are then released from the container enabling them to fall towards the target area. A ball retained by one of the cups on the pole or ground, or a ball closest to the pole is declared the winning ball. The lottery number on the ball is then determined. The participate holding the lottery ticket with a lottery number that matches the lottery number on the winning ball is declared the lottery winner.

### DESCRIPTION OF THE DRAWINGS

FIG. 1 is an illustration of a helicopter with a large container filled with ping pong balls being opened so that the ping pong balls fall onto a target area located below the helicopter.

FIG. 2 is a side elevational view of the large container filled with ping pong balls.

FIG. 3 is a bottom plan view of the large container showing the two doors in a closed position.

FIG. 4 is a side elevational view of the target pole located in the target area with at least one cup mounted thereon designed to catch a ping pong ball.

FIG. 5 is a side elevational view of a ping pong ball and a lottery ticket each having the same lottery number printed thereon.

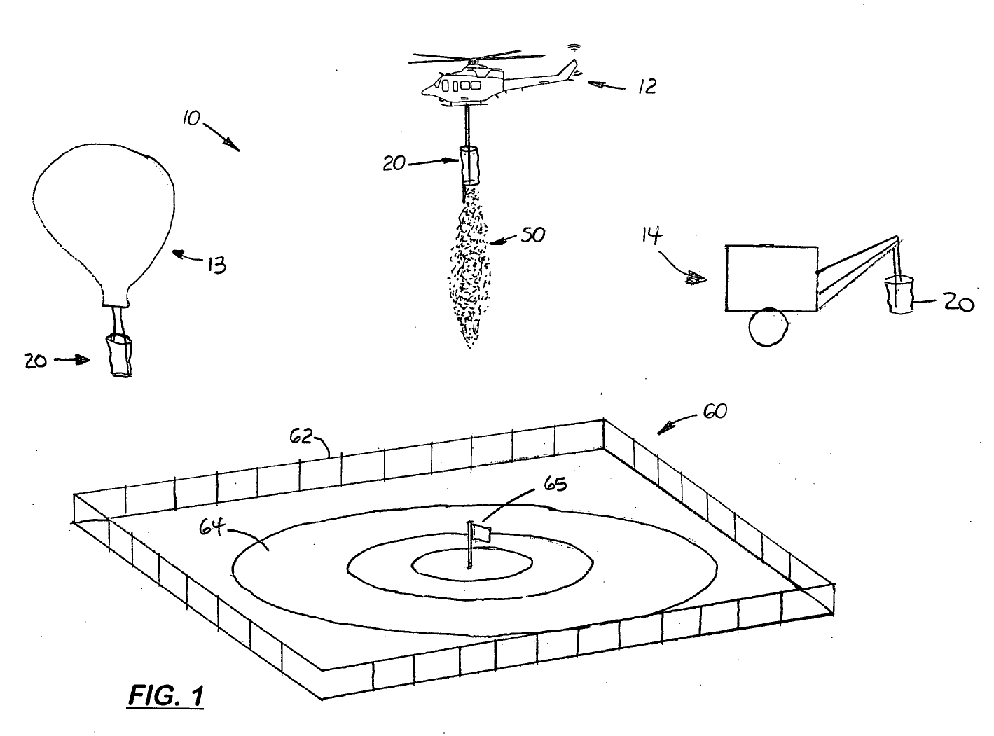

### DESCRIPTION OF THE PREFERRED EMBODIMENT(S)

Referring to the Figs., there is shown a big event, air drop lottery system 10 that includes a lifting apparatus, such as a helicopter 12, a hot air balloon 13, or a crane 14 that lifts a large container 20 filled with a large quantity of ping pong balls 50. The helicopter 12 lifts the container 20 to a desired elevation above a target area 60 and then opens the container 20 to release the balls 50. In the preferred embodiment, a target pole 65 is assembled in the center of the target area 60. The ball 50 that is captured by the target pole 65 or that stops closest to the target 65 is declared the winning ball 50. Each ball 50 includes a lottery number 52 printed thereon that matches the lottery number 82 on a lottery ticket 80 issued to a participant.

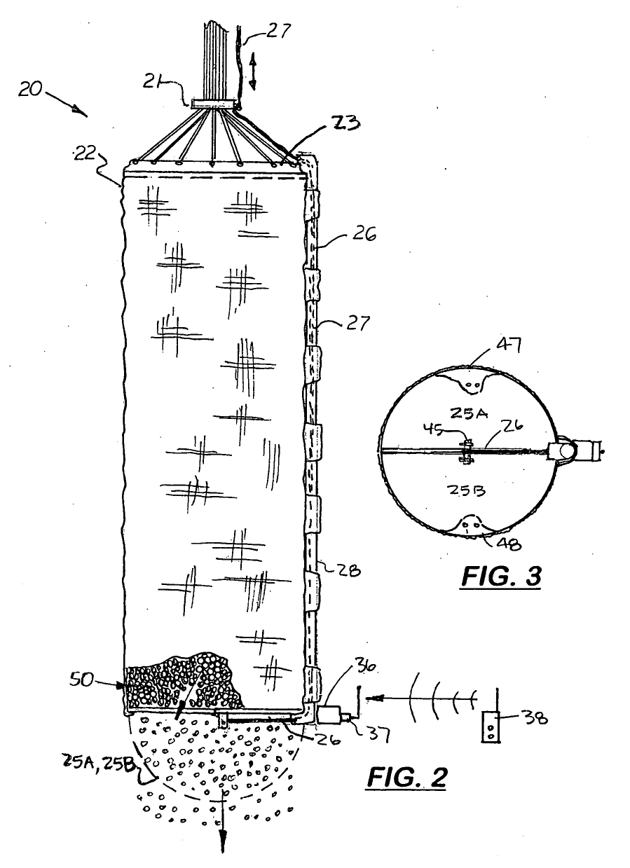

As shown in FIG. 2, the container 20 includes a hollow large cylindrical container body 22 made of flexible material. The rip cord 27 extends downward from the helicopter 12 and pass through a collar 21 and connects to an upper ring member 23 located near the upper edge of the container body 22. Formed on the bottom surface of the container body 22 are two pivoting doors 25A, 25B that are selectively opened or closed by the lottery operator.

In the preferred embodiment, the doors 25A, 25B are opened or closed by a plunger arm 26 that extends inward from the container's lower perimeter edge. As shown in FIG. 3, the two doors 25A, 25B are both attached to two hinges 47, 48 located on its opposite perimeter edges that enable them to pivot downward from their adjacent center edges so that the entire quantity of balls 50 is released from the container body 22.

In a first embodiment, the outer edge of the plunger arm 26 is connected to a rip cord 27 that extends downward through a rigid conduit 28 mounted longitudinally over the outside edge of the cylindrical body 22. The proximal end of the rip cord 27 extends upward through the rigid conduit 28, through the upper ring 21 and to a lottery operator located inside the helicopter 12. The distal end of the rip cord 27 attaches to the plunger arm 26. In a second embodiment, the rip cord 27 is replaced by an electric solenoid 36 connected to a RF receiving unit 37. The RF receiving unit 37 is designed to receive RF signals from an RF transmitter 38 held by a lottery representative on the ground or in the helicopter 12. In the second embodiment, the solenoid 36 is connected to the plunger arm 26. When the plunger arm 26 is pulled, the pin 45 holding the two doors 25A, 25B closed is released so that the two doors open to release the plurality of ping pong balls 50 stored inside the container body 22.

In the preferred embodiment, the container body 22 is designed to hold approximately up to 50,000 ping pong balls 50. It measures approximately 3 to 8 feet in diameter and 10 to 30 feet in length and is made of reinforced vinyl. The rigid conduit 28 is approximately 2 inches in diameter, 40 feet in length and is made of rigid plastic or aluminum. It should be understood that the container body 22 may be manufactured in any size and shape to hold different quantities (as little as 1,000 balls and as much as 100,000 balls) of ping pong balls 50.

The target area 60 is a flat, rectangular or circular field that measures 100 to 600 feet in width or diameter. In the preferred embodiment, a short fence 62 is built around the perimeter of the target area 60 to keep the ping pong balls 50 in a confined area. Also, an optional bull's eye-like visual target 64 is created in the center of the target area 60.

Mounted in the center of the target area 60 is an optional target pole 65. The target pole 65 includes a top cup 66 and a plurality of lower cups 67, 68, 69 each designed to hold at least one ping pong ball 50. In the preferred embodiment, the top cup 66 is designated the winning cup if a ping pong ball 50 is captured therein. The lower cups 67, 68 and 69 are designated second, third and fourth place winning cups, respectively. In the event, that no ball 50 is captured by the top cup 66 the ball 50 in the next highest cup is declared the winning ball. In the event, no ball 50 is captured by any cup, the ball 50 closest to the target pole 65 is declared the winning ball. It should be understood that size and shapes of the cups may be modified. For example, the cups may be funnel-shaped and capable of receiving a plurality of balls with the first or lowest ball captured therein being declared the winner.

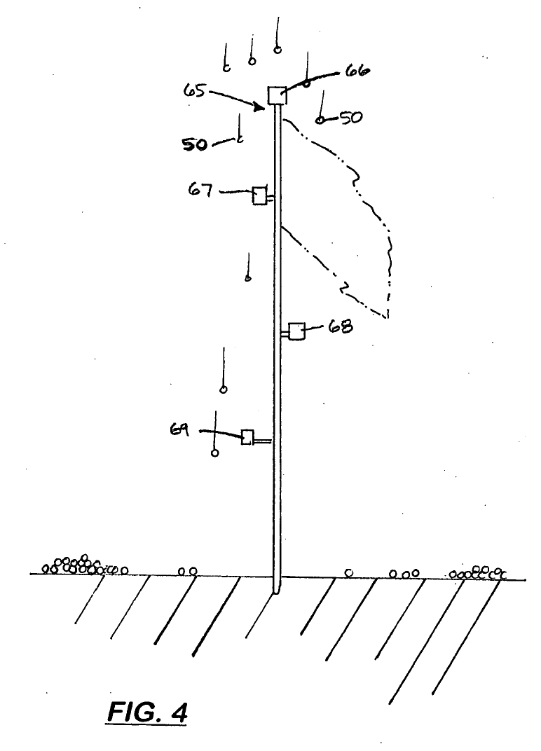

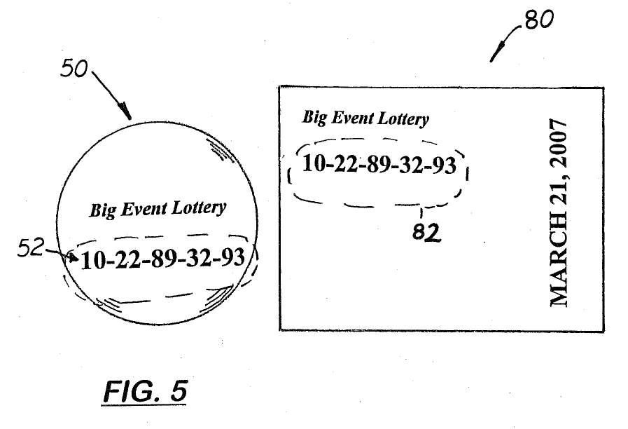

As mentioned above and as shown in FIG. 4, each ball 50 includes a lottery number 52 printed thereon that matches the lottery number 82 printed on a lottery ticket 80 held by a participant. When the ping pong balls 50 are released from the container 20, they fall towards the target area 60. The spectator holding the lottery ticket 80 with a lottery number 82 that matches the lottery number 52 on the winning ball 50 is declared the lottery winner.

In the preferred embodiment, the lifting apparatus is a helicopter 12. It should be understood, however, that the lifting apparatus may be a hot air balloon, or crane.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A big event, air drop lottery system, comprising:
a. a lifting apparatus;
b. a large container with a lower opening capable of being selectively opened or closed, said large container being connected to said lift apparatus and lifted to a desired height;
c. a plurality of ping pong balls are placed inside said large container, each said ping pong ball includes a unique lottery number;
d. a designated target area located below said large container;
e. a plurality of ticket stubs each having a unique lottery number that matches at least one unique lottery number on said ping pong balls placed inside said large container; and,
f. at least one prize to be awarded to the holder of said ticket that has the lottery number that matches the lottery number on a ball dropped into said target area and declared a winning ball.

2. The big event, air drop lottery system, as recited in claim 1, wherein said lifting apparatus is a helicopter.

3. The big event, air drop lottery system, as recited in claim 1, wherein said lifting apparatus is a hot air balloon.

4. The big event, air drop lottery system, as recited in claim 1, wherein said lifting apparatus is a crane.

5. The big event, air drop lottery system, as recited in claim 1, further including a target structure located inside said target area.

6. The big event, air drop lottery system, as recited in claim 5, wherein said target structure is a target pole.

7. The big event, air drop lottery system, as recited in claim 6, wherein said target pole includes at least one cup mounted thereon that is able to capture a ping pong ball.

8. The big event, air drop lottery system, as recited in claim 1, wherein said large container is sufficient in size to hold 1,000 to 100,000 ping pong balls.
